(19) United States
(12) Patent Application Publication
(10) Pub. No.: US 2007/0198141 A1
(43) Pub. Date: Aug. 23, 2007

(54) Cockpit display system

(75) Inventor: Tim G. Moore, Ottawa (CA)

Correspondence Address: NELSON MULLINS RILEY & SCARBOROUGH, LLP, 1320 MAIN STREET, 17TH FLOOR, COLUMBIA, SC, 29201, US

(73) Assignee: CMC Electronics Inc., St. Laurent (CA)

(21) Appl. No.: 11/358,881

(22) Filed: Feb. 21, 2006

(51) Int. Cl. G01C 23/00

(52) U.S. Cl. 701/3; 701/9

(57) ABSTRACT

A cockpit display system has a display, such as a multi-function display (MFD) for displaying a graphical representation of an input device when a sensor senses that an aviator's finger is proximate to the input device. The display graphically depicts in real-time the position of the aviator's finger relative to the buttons of the input device. The aviator's finger can be depicted by an icon, shading or highlighting. When the aviator lightly touches a button, the graphical representation of that button can for example be highlighted, shaded or colored. Furthermore, when the button is firmly depressed, the graphical representation of that button can change color or shading. The aviator can thus operate any awkwardly located input device by simply reaching toward the input device and then guiding his finger to the correct button by looking at the graphical representation of the input device.

### CROSS-REFERENCE TO RELATED APPLICATIONS

This is the first application filed for the present invention.

### TECHNICAL FIELD

The present invention relates generally to avionics and, in particular, to cockpit display systems.

### BACKGROUND OF THE INVENTION

Aviators must constantly maintain situational awareness when flying. However, tasks such as the entry of navigation data and/or the changing of communication settings by the pilot or copilot tend to divert attention away from the primary flight instruments and from the outside world.

Designing an aircraft's cockpit to provide an ergonomic layout of the aircraft's controls and instruments requires a careful optimization of both instrument visibility and physical accessibility to the controls. Primary flight controls and instruments should be located within easy reach and within (or at least close to) the pilot's natural field of vision (primary flight instruments are optimally located about 15 degrees below the forward line of sight). Controls and instruments that are operated and consulted less frequently than the primary ones are typically located in less visible and less accessible places within the cockpit such as on a central console between pilot or co-pilot or on the ceiling of the cockpit.

However, during flight, operating a control panel or input device that is awkwardly located leads to pilot fatigue and loss of situational awareness. This is particularly problematic when flying in bad weather, at night, or in a combat environment.

Control and display units (CDUs) for inputting navigation and communications data in both fixed-wing aircraft and rotorcraft are typically placed close to the pilot's thigh or knee, such as for example on a central console between the pilot and the copilot. While a full QWERTY-type keyboard might enable a pilot to touch-type (by memory of the keyboard), there is seldom enough space in the cockpit for a full QWERTY keyboard. However, the CDU (or pair of CDUs for two-seaters) is usually located beside the pilot (e.g. on the central console in a two-seater) and thus can only be operated using one hand. This requires the pilot or copilot to look down and sideways when entering data on the keypad of the CDU (which degrades situational awareness by diverting attention away from the primary flight instruments and outside environment). This is the layout, for instance, in the Bell-Textron CH-146 Griffon helicopter. Unfortunately, the location of the CDUs in the cockpit of the CH-146 Griffon has led to several incidences of severe neck pain reported by pilots, especially when they were wearing helmets and night-vision goggles (NVGs).

Another problem arising from the awkward location of the CDUs (again for example in the CH-146 Griffon) is that the pilots were reporting dizziness and nausea because of the Coriolis Effect resulting from looking down and sideways when being subjected to linear and/or angular accelerations.

One solution to the problem of awkwardly located input devices is to utilize heads-up displays (HUDs) or multi-function displays (MFDs) to efficiently display relevant information in a location that is readily consulted with a mere glance downward from the straight-ahead line-of-sight so as to liberate cockpit space for controls. Another suggested approach is to use touch-sensitive screens, but these have proved unsuitable because it is awkward to enter long sequences of data by extending one's arm straight outward, especially when subjected to high g forces. For entering long sequences of data for navigation and communication, a forward-mounted touch-sensitive screen is difficult to operate for the pilot or copilot.

Another approach to preserving situational awareness by enabling ergonomic data input involves visually presenting the keypad to the user in a HUD and tracking the keys that are selected by the user. For example, Technical Report UMTRI-2002-6 (Mar. 6, 2002) entitled “HUD Feedback to Minimize the Risk of Cellular Phone Use and Number Entry While Driving” describes a HUD that projects a keypad of a cell phone. A joystick is mounted on the steering wheel to enable the driver to enter numbers on the keypad in order to dial a number without having to look at the cell phone's actual keypad. However, this technology requires an additional, proxy input device (the joystick) which increases cost, complexity and occupies useful space. Furthermore, the HUD has to be activated by the user (which requires looking or feeling for the specially located joystick) when placing a call (or it is always on, in which case the HUD projection of the keypad is an unnecessary distraction when not in use).

A related technology has emerged in the field of personal computing. The TactaPad™ by Tactiva has a camera that captures images of a user's hands. The image of the user's hands is then translucently overlaid on the user's display as live video. The user can then press (with one or more fingers) at any point (or points) on a rectangular touch-sensitive pad that corresponds proportionately to the display. When the user touches the tactile-sensitive pad, a cursor appears on the corresponding location of the display (or alternatively menus, icons or objects can be clicked, double-clicked or dragged). However, the TactaPad does not display a representation of a keypad or other input device, but merely displays a software-generated screen of a given program (as any typical monitor does for a PC or laptop) but which the user can manipulate using the TactaPad as an input device rather than using a mouse, touchpad or trackball.

Therefore, an improved display system that enables ergonomic data input, especially for an aircraft cockpit where situational awareness must be preserved, remains highly desirable.

### SUMMARY OF THE INVENTION

This invention provides a display system, primarily for a cockpit of an aircraft, that is capable of intelligently or selectively displaying a graphical representation of an input device (e.g. a control and display unit, keypad or other such control panel) on a display (e.g. a multi-function display, heads-up display or the like) when an user's finger is detected close to the input device. The display can graphically depict in real-time the position of the user's finger over the input device. The display can also highlight, color or shade input elements (e.g. keys) of the input device when they are lightly touched and/or highlight, color or shade those keys that are firmly depressed. Optionally, the display can “gray out” any inactive keys to facilitate data entry. Similarly, the display can present a simplified representation of the input device based on the type of data being entered and/or the desired type of input for a given set of operational circumstances. The user's finger (or hand) is sensed by a sensor such as a pair of digital cameras or an infrared sensing plane defined by orthogonal infrared sources. The position of the user's finger can be triangulated from the captured image data and then correlated to a particular input element (e.g. key) of the input device.

The primary application of this invention is for aircraft cockpits where input devices such as control and display units are awkwardly located. For example, in many cockpits (such as in the cockpit of the two-seater Bell-Textron CH-146 Griffon helicopter), the pilot and copilot sit side-by-side and between them is a pair of control and display units (CDUs) for entering navigational data and setting communication frequencies. However, because of limited space in the cockpit, the CDUs are located on a central console in a position which makes it very awkward for an aviator to operate because the aviator must look downwardly and sideways in order to operate the keypad. Operating a mid-mounted CDU (or other awkwardly positioned keypads or controls) undesirably diverts the aviator's eyes away from the forward-facing field of view, i.e. away from the primary flight instruments and front windshield.

Furthermore, the frequent displacement of the aviator's head and the continual refocusing of his eyes in looking back and forth from the forward view and the CDU (or other input device) lead to both neck and eye strain. Specifically, aviators operating the CDU in the CH-146 Griffon have reported severe neck pain, especially when wearing night-vision goggles. A further problem associated with the head postures required to look at the mid-mounted CDU is that the Coriolis Effect can lead to dizziness and nausea (resulting from looking down and sideways when subjected to linear and rotational accelerations).

The invention described herein substantially alleviates these problems by providing a more ergonomic cockpit display system. The display system intelligently displays a graphical representation of the input device (e.g. the CDU) on a display (e.g. an MFD) when the aviator's finger is sensed to be in the proximity of the input device. The MFD (or other display) is disposed ergonomically within (or at least very close to) the pilot's forward-facing field of vision.

The invention also has utility in numerous other applications, such as road vehicles, water vehicles or cranes where ergonomics and external view of the situation are important considerations and where it is desirable to reduce user workload and neck and eye strain during operation of vehicles or equipment.

Therefore, in accordance with one aspect of the present invention, a cockpit display system for displaying aircraft controls and instrumentation includes an input device for receiving input from an aviator, a sensor for sensing a proximity of an aviator's finger or hand to the input device, and a display for displaying a graphical representation of the input device when the sensor detects that the aviator's finger or hand is proximate to the input device.

In one embodiment, the display further includes a real-time graphical depiction of a position of the aviator's finger or hand relative to the input device.

In another embodiment, the display further graphically indicates an element of the input device when the aviator's finger is proximate to the element.

In another embodiment, the display indicates the current setting for a control element based on a previous depression of a key (a SHIFT function) or based on a software state or mode.

In yet another embodiment, the display highlights the key with a distinct color when the aviator's finger lightly touches the key and highlights the key with another distinct color when the aviator's finger depresses the key.

In a further embodiment, the display indicates one or more inactivated keys with a grayed-out shading to indicate to the aviator that the one or more keys do not support any useful functionality at that particular time.

In yet a further embodiment, the sensor includes two orthogonal pairs of opposed, inwardly facing elongated infrared lamps defining a rectangular enclosure surrounding the input device, the elongated infrared lamps emitting infrared light to define a sensing plane slightly above the input device; a digital camera located at each of the four corners of the rectangular enclosure for capturing digital images of the aviator's finger when placed within a field of vision of each the four cameras; and a processor for triangulating a planar position of the finger over the input device and for correlating the position of the finger with one of a plurality of input elements of the input device.

In accordance with another aspect of the present invention, a display system includes an input device for receiving input from a user, a sensor for sensing a position of a user's finger relative to the input device and for generating a signal when the position of the user's finger relative to the input device is closer than a predetermined proximity threshold, and a display for displaying a graphical representation of the input device in response to the signal.

In one embodiment, the display graphically depicts in real-time the position of the user's finger relative to the input device. Optionally, the display also graphically depicts light contact between the user's finger and an input element of the input device to indicate to the user that the user has lightly touched the input element but has not yet fully actuated the input element. Optionally, the display graphically depicts full actuation of the input element in a manner that is visually distinct from a graphical depiction of light contact.

in another embodiment, the input device is a keypad having a plurality of keys, wherein the display graphically depicts the position of the user's finger with a first visual cue, light contact with any of the keys with a second visual cue and full actuation of any of the keys with a third visual cue. Optionally, the display graphically depicts inactive keys with a fourth visual cue. Optionally, the display graphically depicts the current mode of keys with a fifth visual cue. Optionally, the display graphically highlights the key that is determined to be closest to the user's finger.

In yet another embodiment, the sensor includes a plurality of infrared sources emitting infrared light in a sensing plane; a plurality of digital cameras for detecting the user's finger when situated in the sensing plane, the sensing plane being disposed above and parallel to the input device to thus define the predetermined proximity threshold for activating the graphical representation of the input device on the display; and a processor for triangulating the position of the user's finger when placed into the sensing plane.

In accordance with yet another aspect of the present invention, a method for displaying an input device on a display to enable a user to ergonomically operate the input device while looking at a graphical representation of the input device on the display includes steps of: sensing a user's finger or hand, and displaying the graphical representation of the input device on the display when the user's finger or hand is sensed to be in contact with, or proximate to, the input device. The method can be used to detect either a finger, a plurality of fingers or a hand. The method enables graphical representation of a number of different input devices in aircraft, automobiles, other vehicles or in stationary equipment where ergonomics and/or high-speed situational awareness are important. In an aircraft, for example, the input device could be a control and display unit (CDU), a manual throttle controller, a ceiling-mounted panel of toggle switches or any other control, keypad, keyboard, mouse, switch, toggle or device used to control the aircraft and its equipment or to input data for navigation, communication or other functions.

In one embodiment, the sensing step includes emitting infrared light from at least two orthogonal infrared lamps to define a sensing plane slightly above the input device, capturing digital images of the user's finger with digital cameras, triangulating a planar position of the user's finger over the input device, and correlating the position of the user's finger with one of a plurality of input elements of the input device.

In another embodiment, the input device is a control and display unit (CDU) having a keypad and screen for receiving and displaying various types of input from an aviator, the display also displaying a graphical representation of the keypad and screen of CDU.

In yet another embodiment, the displaying step includes a step of displaying the graphical representation of one or both of a pair of side-by-side control and display units on at least one multi-function display having a split-screen capability.

In a further embodiment, the displaying step comprises a step of graphically depicting a real-time position of the user's finger relative to input elements of the input device. The method can further include a step of graphically depicting light contact between the user's finger and one or more of the input elements of the input device. The method can further include a step of graphically depicting an act of depressing one or more of the input elements of the input device. The method can further include a step of graphically depicting inactive keys. The method can further include graphically depicting only active input elements and relevant input element labels, thereby visually presenting to the user a simplified version of the input device. The method can further include graphically depicting either only letter labels or number labels inscribed on the keys of the keypad depending on a type of data being input.

The cockpit display system and the associated method of displaying an input device described in the present application represent a substantial innovation over the prior art. This display system and method confer a number of significant benefits to aviators (or drivers or other users). By sensing when a user reaches for a particular input device (e.g. a keypad) and by displaying a graphical representation of that input device on a readily visible display, operation of that input device is greatly facilitated. No longer must the user look at the input device to accurately touch its keys, since the user is guided to the correct keys by observing the position of his finger or hand relative to the keys as depicted in real-time by the display. Accordingly, the user (e.g. aviator) can readily and ergonomically view the display with very minimal diversion of his eyes from the desired (forward-facing) field of vision. Specifically, an aviator in flight can operate the input device while maintaining close visual contact with the outside environment through the front windshield and with the primary instrument panels. Accordingly, operation of an input device such as a centrally located control and display unit (CDU) is possible because the CDU is displayed on an easily visible front-mounted multi-function display (or equivalent display). The aviator (pilot or copilot) can accurately enter data into the CDU. The aviator's eyes flicker up and down only a few degrees between the windshield and/or primary flights instruments and the MFD. Dizziness, vertigo, motion sickness, neck and shoulder fatigue are all greatly reduced as a result of this innovation.

Although the primary application of this invention is a cockpit display system for displaying awkwardly situated input devices on a display to enable aviators to ergonomically select and operate the input devices, the invention also has utility for controlling other types of vehicles or machinery.

### BRIEF DESCRIPTION OF THE DRAWINGS

Further features and advantages of the present invention will become apparent from the following detailed description, taken in combination with the appended drawings, in which:

FIG. 1 is a perspective view of a cockpit display system in accordance with an embodiment of the present invention;

FIG. 2 is a perspective view of a keypad input device and a display displaying the input device where the annular icon represents the real-time position of a user's finger, a light shading (a first color) represents light contact with a key, and dark shading (a second color) represents the depressing of a key;

FIG. 3A is a perspective view of a keypad input device and a display displaying the input device where certain keys (in this example the numeric keys) are grayed out graphically to indicate to the user that these keys have no useful functions at that particular time;

FIG. 3B is a perspective view of a keypad input device and a display displaying the input device wherein the aviator can cause the display to display only the numbers on the graphical representation of the keypad;

FIG. 3C is a perspective view of a keypad input device and a display displaying the input device wherein the user can cause the display to display only the letters on the graphical representation of the keypad;

FIG. 4 is a side view of a helicopter cockpit in which the input device is a ceiling-mounted panel of switches which is selectively displayed on one or more displays when one of the aviators reaches for that panel of switches;

FIG. 5 is a top plan view of an infrared sensor having two orthogonal pairs of infrared lamps defining a rectangular enclosure surrounding a pair of control and display units (CDUs), the four infrared lamps emitting infrared light over the CDUs to define a sensing plane which, when penetrated by a user's finger, triggers the displaying of the CDUs on the display;

FIG. 6 is a top plan view corresponding to FIG. 5 showing how four digital cameras (one located at each corner of the sensor's rectangular enclosure) can redundantly triangulate the position of the user's finger for correlation with a particular key of the underlying CDU keypad;

FIG. 7 is a side elevation view of the infrared sensor enclosure shown in FIGS. 5 and 6; and

FIG. 8 is a perspective view of a display system in accordance with another embodiment of the present invention in which a pair of digital images capture image data of a user's finger for processing and correlation with a key of the keypad.

It will be noted that throughout the appended drawings, like features are identified by like reference numerals.

### DESCRIPTION OF PREFERRED EMBODIMENTS

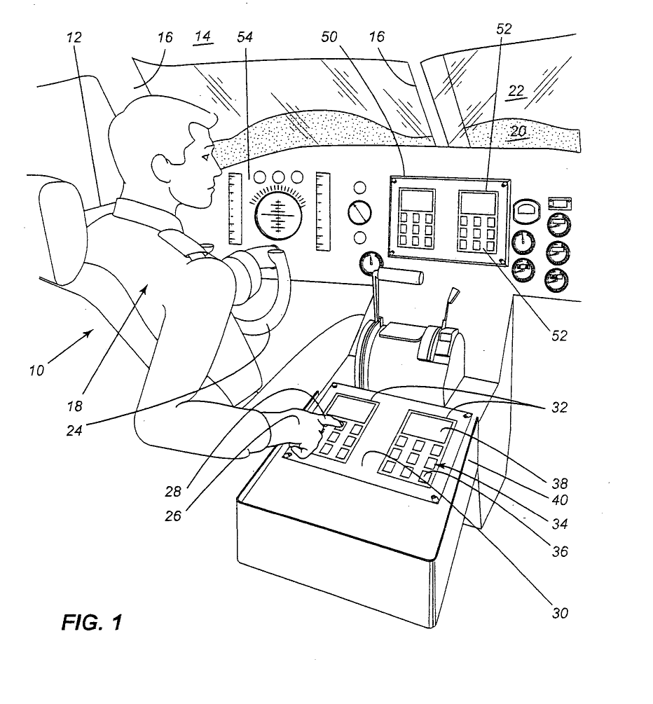

In accordance with a preferred embodiment of the present invention, a cockpit display system for displaying aircraft controls and instrumentation is illustrated in FIG. 1. This perspective view of an aircraft's cockpit shows a two-seater side-by-side configuration for a pair of aviators (pilot and copilot) as is commonly found in many fixed-wing aircraft and rotorcraft. Although specific cockpit configurations and layouts are shown in the this and subsequent figures, it should be understood that the embodiments of the present invention can be applied to any type of aircraft cockpit to intelligently display input devices when sought by the aviator's finger or hand.

As shown in FIG. 1, the cockpit, which is generally designated by reference numeral 10, is situated at a forward portion of an airframe 12 of the aircraft and has a windshield 14 (supported by windshield frame members 16) through which an aviator 18 (i.e. a pilot and optionally also a copilot) can see the outside world, particularly the ground or terrain 20 and the sky 22. The aviator 18 can control the movement of the aircraft during flight (i.e. its pitch, roll and yaw) using a control stick 24, as is well known in the art. As is also well known in the art, the aviator 18 also controls a panoply of other aircraft functions by operating one or more input devices 30 using a hand 26 or a finger 28. For example, the aviator uses his hand to operate an input device such as manual throttle controller (not shown, but well known in the art) to increase or decrease engine power. The aviator also uses his finger (or fingers) to operate an input device 30 such as, for example, a pair of side-by-side control and display units (CDUs) 32 as shown in FIG. 1. The pair of CDUs 32 can be used, for example, to enter alphanumeric data for navigation or communication, or for other aircraft functions.

As shown in FIG. 1, each CDU 32 has a keypad 34 having a plurality of keys 36. Each CDU also has a small display screen 38 which can display a variety of information such as (depending on the type of CDU) the data as its being input, prompts for entering other input and/or current or previous settings. Entering a string of alphanumeric data into a CDU (for example when inputting navigation data or changing communication settings) tends to divert the aviator's attention away from the primary flight instrument panel and from the outside world. This not only degrades situational awareness but it also causes eye and neck strain, and in some instances dizziness and nausea. A solution to these problems is provided by the present invention.

Therefore, in accordance with a preferred embodiment of the present invention, the cockpit display system includes a sensor 40 for sensing a proximity of an aviator's finger 28 or hand 26 to the input device 30. The cockpit display system also includes a display 50 for displaying a graphical representation 52 of the input device 30 when the sensor 40 senses that the aviator's finger 28 or hand 26 is proximate to the input device 30.

The display 50 is preferably a flat-screen (e.g. LCD) multi-function display (MFD), but it can also be a conventional CRT-type MFD, heads-up display (HUD), helmet-mounted heads-up display or any other display device capable of displaying a graphical representation of the input device. As shown in FIG. 1, the display 52 is preferably disposed to be readily visible to the aviator (most preferably about 15 degrees below the straight-ahead line of sight) such as beside a primary flight instrument panel 54 (although any other reasonably ergonomic configuration could be implemented to at least partially yield the benefits described in the present application). The display 50 can also be an LCD multi-function display (MFD) having a split-screen capability for simultaneously displaying two or more input devices or, by way of example, for showing only one of the pair of CDUs 32 at a time while using the remaining portion of the MFD for displaying maps or other relevant information.

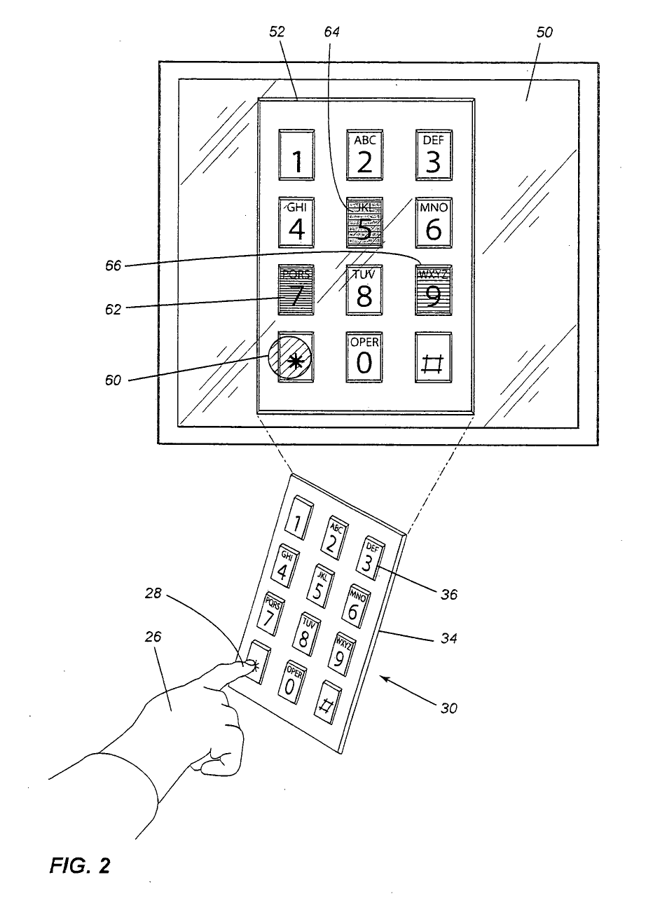

In the preferred embodiment, as illustrated in FIG. 2, the display 50 can also graphically depict in real-time a position of the aviator's finger 28 or hand 26 relative to the input device 30. Preferably, the real-time position of the aviator's finger is graphically depicted using a first visual cue or indicator such as, by way of example only, an annular icon 60, as shown in FIG. 2. Alternatively, or in addition to this first visual cue or indicator, the display can highlight, shade or color the closest or most proximate key to the aviator's finger in real-time so as to indicate (using another visual cue 62) to the aviator which key would be contacted if the aviator were to move his finger a bit further downward. Preferably, the display 50 further graphically depicts or otherwise indicates when the aviator's finger has lightly touched a key 36 (or “input element”) of a keypad 34 (or other “input device”). This can be done using a different visual cue 64 that highlights, shades or colors the key being lightly touched in a visually distinct and easily recognizable manner. Furthermore, the display 50 can highlight the key with yet a different visual cue or indicator 66 (i.e. a different color, shading or highlighting or a different-looking icon) when the aviator's finger depresses the key.

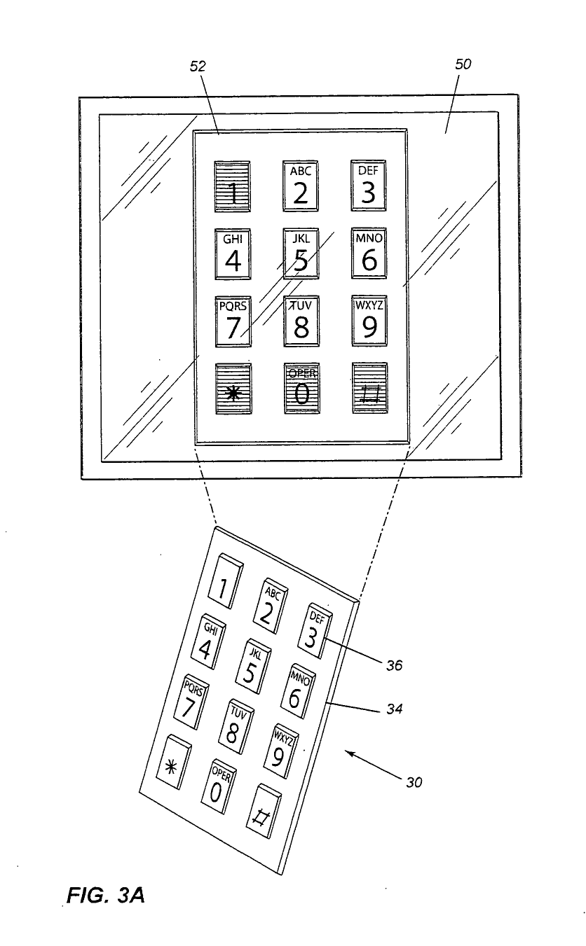

As illustrated in FIG. 3A, the display 50 can also indicate one or more inactivated keys with a grayed-out shading 68 to indicate to the aviator that the one or more keys do not support any useful functionality at that particular time. FIG. 3A shows, by way of example only, the graying-out of those keys in an alphanumeric, telephone-type keypad that do not support letter input. This refinement helps the aviator to select only keys that provide useful data input in a given context.

As illustrated in FIG. 3B, the keypad 34 can have a DELETE or DEL key 31a, a SHIFT key 31b and an ENTER key 31c to facilitate data entry. The aviator can toggle the display (for example by pressing the SHIFT key 31b) so that the display depicts only the numbers on the representation of the keypad. In this example, toggling the SHIFT key 31b again would cause the display to present the keypad with both numbers and letters as shown in FIG. 3A. Conversely, as illustrated in FIG. 3C, the aviator can toggle the SHIFT key 31b (or other key) to cause the display to depict the keys with letters only. Again, pressing the SHIFT key 31b would cause the display to graphically depict both the keypad with both letters and numbers. Graphically presenting a simplified depiction of the keypad makes it easier for the aviator to enter data accurately and hence reduces workload.

In the preferred embodiment, therefore, the display 50 presents a graphical representation of one or both of the CDUs when the sensor 40 senses the proximity of the aviator's finger to the CDU. In other words, the presence of the aviator's finger proximate to the input device triggers or activates the displaying of the graphical representation of the input device (e.g. the pair of CDUs). The cockpit display system of the present invention can thus “intelligently” or “selectively” display whichever input device the aviator reaches for or whichever the aviator touches, depending on whether proximity or actual contact is required to trigger the displaying of the input device. In other words, an MFD can be used to instantly switch between displays of any of a plurality of input devices in the cockpit as the aviator's finger (or hand) reaches for the desired input device. The cockpit display system thus continually and intelligently displays to the aviator the input device that he is using or about to use. Alternatively, in another embodiment, the display 50 can be dedicated to displaying a particular input device, in which case the cockpit display system can activate or “light up” the display when the aviator reaches for it or touches it, or it can be “on” all the time (i.e. continually actively displaying the input device) in which case this simplified variant of the cockpit display system merely functions to facilitate data entry by the aviator by guiding the aviator's finger to the correct keys. In another embodiment, the display can be manually changed (using a manual override switch) to select the input device that is to be displayed on the display.

However, in the preferred embodiment, and by way of example only, the display 50 graphically depicts the real-time position of the aviator's finger using a moving annular icon that is overlaid on the graphical representation of the CDUs. This annular icon should be large enough to be readily visible but not so large that it unduly obscures the underlying graphics. Preferably, the key closest to the aviator's finger at any given moment is highlighted or shaded with a particular color or distinct type of shading (for example green) In this preferred embodiment, when the aviator lightly touches a key, that key is colored or shaded with a visually distinct color or shading (for example yellow). When the key is depressed, the key is shown highlighted with another color or shading (for example red). These colors are of course simply illustrative of one of many possible ways of providing distinct visual cues to the aviator.

As will be appreciated, once the aviator's finger has been sensed and positioned relative to the input device, any number of graphical depictions (using any number of colors, shading, icons and other visual or even audible cues can be used to indicate to the aviator where his finger is positioned relative to the various input elements (or keys) of the input device, what input elements he is touching, what input elements he is pressing (or has pressed), and what input elements support no useful functionality at that time.

Therefore, the aviator can operate the CDU (or other awkwardly positioned input device) by looking at the graphical representation of the CDU on the display and by guiding his finger to the desired key or keys by looking at the real-time position of his finger and the keys he is proximate to, actually touching or firmly depressing. In other words, the aviator can enter complex sequences of data into the CDU without having to look down and sideways at the real CDU. As a consequence, the aviator is neither subjected to the neck and eye strain nor to the dizziness and nausea that are often associated with operating the mid-mounted CDU during flight. This ergonomic cockpit display system thus reduces aviator strain and workload and helps to maintain situational awareness. As will be readily appreciated, this invention has the potential to significantly improve aviation safety.

The graphical representation of the input device can be simplified by presenting on the display only those aspects of the input device that are relevant to the current function of the input device. For example, where the input device has an alphanumeric keypad having a plurality of keys upon which are inscribed both numbers and letters and having a manual switch for switching between numeric and alphabetic input, the display can automatically present only either the numbers or the letters depending on the data type being input, thereby simplifying visual presentation of the keypad to the aviator.

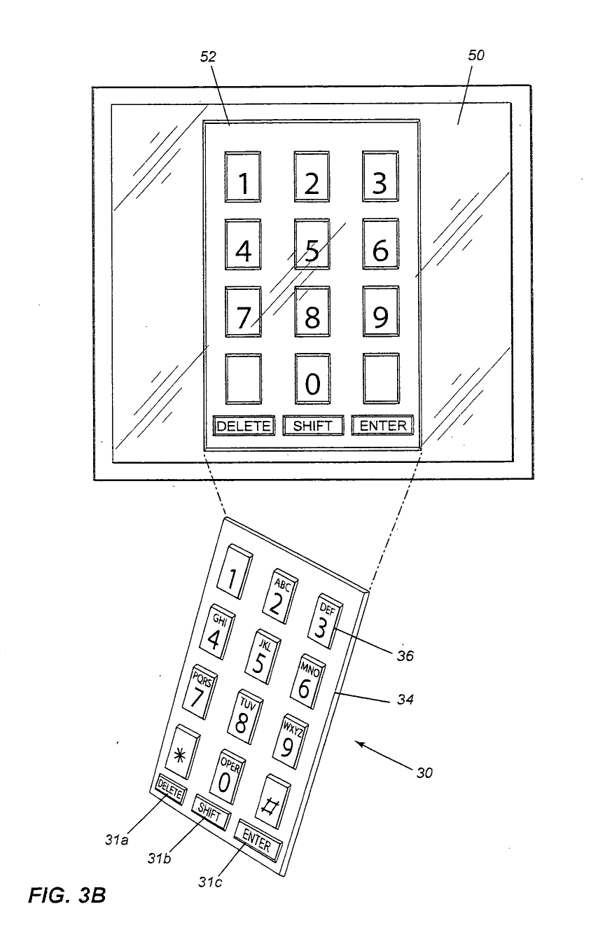

FIG. 4 illustrates another embodiment of the present invention in which the cockpit display system graphically represents a ceiling-mounted panel 33 of toggle switches 35 (or buttons) on a multi-function display 50 (or other type of display) to enable the copilot to see the various switches of the ceiling-mounted panel and to see where his finger is relative to those switches. The display graphically depicts the panel of toggle switches when the sensor detects that the aviator's hand is closer to the panel of toggle switches than a predetermined proximity threshold. As shown in FIG. 4, the copilot and pilot are wearing bulky and heavy helmets equipped with night-vision goggles (NVGs) which make it very difficult to look up at the ceiling-mounted panel of switches. In order to toggle one of the switches, the aviator typically must remove the NVGs. With the cockpit display system of the present invention, the aviator can operate the switches on the ceiling-mounted panel without having to remove the NVGs and without having to look upward at the panel of switches during flight.

The sensor 40 of this cockpit display system senses the proximity of the aviator's finger to the input device and, if the finger is closer than a predetermined proximity threshold, the cockpit display system triggers the displaying of the graphical representation of the input device on the display.

The sensor 40 preferably includes a plurality of infrared (IR) sources (that is, at least two orthogonally disposed IR lamps) defining a sensing plane substantially parallel to the input device. The sensing plane is preferably located approximately 1/16 to ⅛ of an inch (1.6 mm to 3.2 mm) above the input device. At least two cameras capture images of any object (e.g. finger that penetrates the sensing plane) and a processor triangulates the position (or x-y coordinates) of the object in two-dimensional space. The coordinates of the object (finger) are then correlated to the keys (input elements) of the input device.

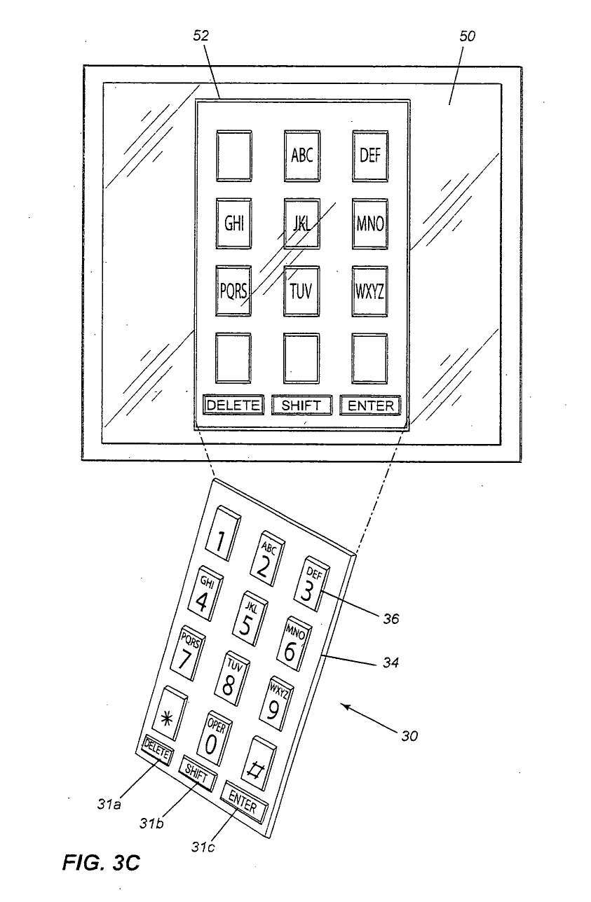

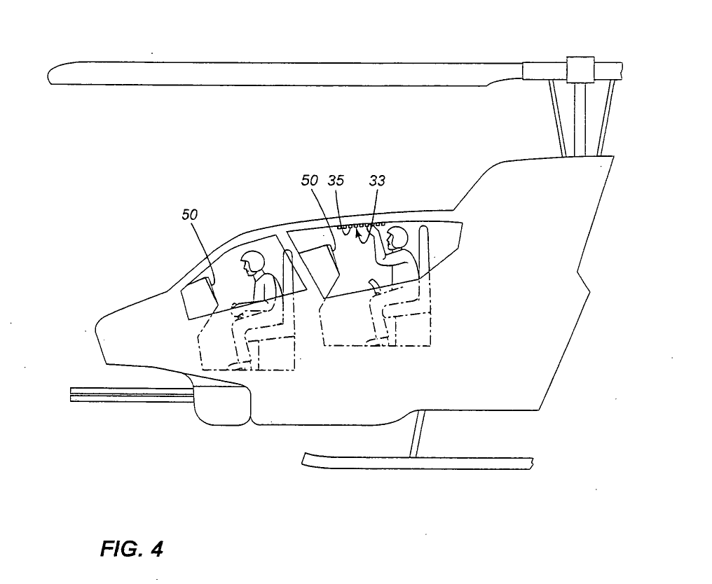

Preferably, as illustrated in FIGS. 5 and 6, this infrared sensor 40 includes two orthogonal pairs of opposed, inwardly facing elongated infrared lamps (that is four IR lamps 72, 74, 76, 78) defining a rectangular enclosure 70 surrounding the input device 30, e.g. a pair of CDUs 32, which are shown in stippled lines in these two figures. The four elongated infrared lamps 72, 74, 76, 78 emit infrared light 80 to define a sensing plane slightly above the input device 30. The infrared sensor preferably also includes four digital cameras 82, 84, 86, 88, one such camera being located at each of the four corners of the rectangular enclosure 70 for capturing digital images of the aviator's finger when placed within a field of vision of each the cameras. A processor (not shown, but well known in the art) triangulates a planar position of the finger over the input device, i.e. computes the finger's x-y coordinates in real-time, and then correlates the position of the finger with one of a plurality of input elements (e.g. the keys) of the input device (e.g. the CDU), as depicted in FIG. 6.

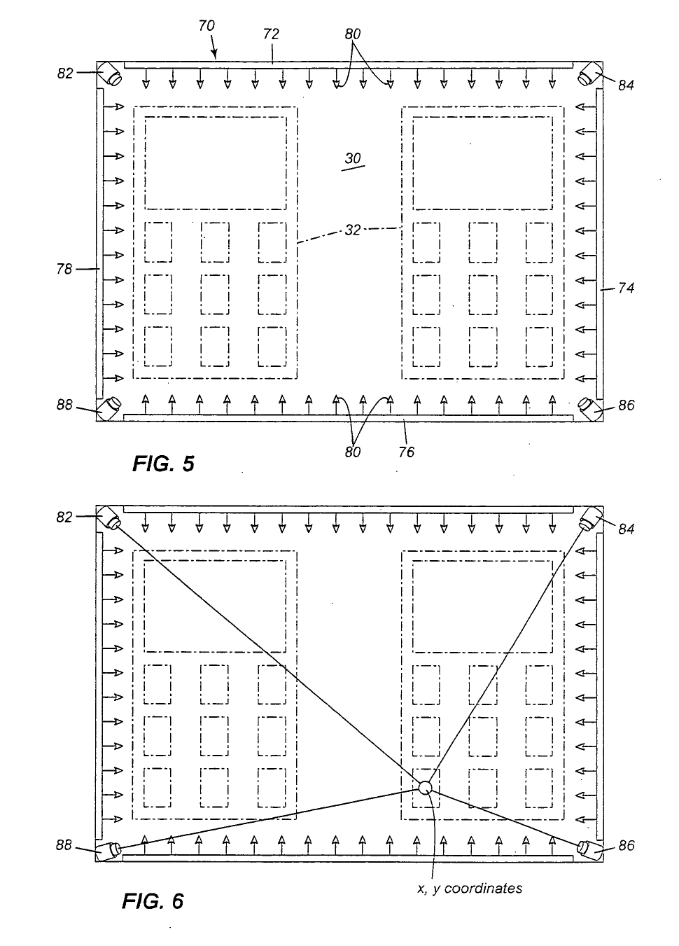

As illustrated in FIG. 7, the sensing plane 90 is defined by the infrared light 80 being emitted by the cameras (in this view, only two cameras 72, 76 are shown, but preferably four cameras are used to provide superior resolution). The sensing plane is about 1/16 to ⅛ of an inch (1.6 mm to 3.2 mm) above the top surfaces of the keys 36 of the keypad 34. The expression “predetermined proximity threshold” used in the present specification means the distance above the input device at which the sensor detects the finger and triggers activation of the display. Therefore, the predetermined proximity threshold corresponds in this example to the height h of the sensing plane (which is preferably about 1/16 to ⅛ of an inch, or 1.6 mm to 3.2 mm). The predetermined proximity threshold can be varied depending on the type of input device and the degree of responsiveness that is sought.

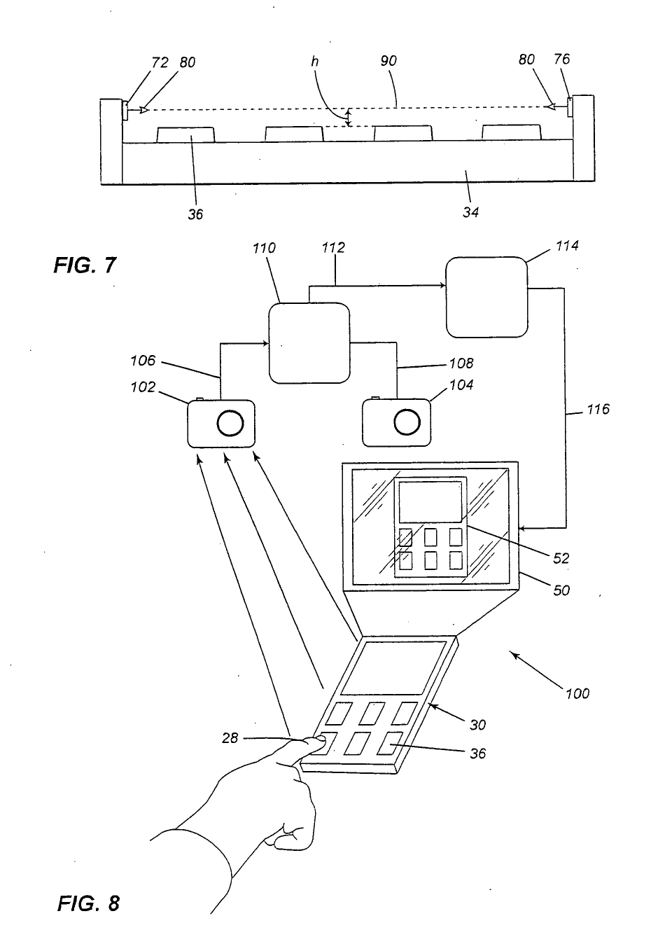

As illustrated in FIG. 8, another embodiment of a cockpit display system 100 can be implemented using a different type of sensor, such as for example a sensor that uses at least two digital cameras 102, 104 for generating image data of an aviator's finger relative to the input device 30. Image data signals 106, 108 are generated and sent to a processor 110 which processes the two incoming sets of frames of image data to resolve a three-dimensional position of an aviator's finger relative to the input device. The processor 110 also determines whether the three-dimensional position of the aviator's finger is within a predetermined proximity threshold of the input device. If so, the processor triggers activation of a graphical representation 52 of the input device 30 on the display 50. Preferably, the processor also transmits a position signal 112 to a position correlator 114 which correlates the real-time position of the finger 28 with a key 36 (or input element) on the input device 30.

Although the foregoing has described and illustrated the input device as a control and display unit (CDU) (or a pair of CDUs) or as a ceiling-mounted panel of switches in an aircraft cockpit, it should be readily appreciated that the input device could be any control or input device in a cockpit, including toggle switches, manual throttle controllers (or levers) or any input devices used for avionics, communications, navigation, weapons delivery, identification, instrumentation, electronic warfare, reconnaissance, flight control, engine control, power distribution, support equipment or other onboard functions that the pilot, copilot, navigator or other aviator can control.

Furthermore, this invention could be used in automobiles or other vehicles that have awkwardly positioned controls or input devices and where it is desirable to enhance situational awareness when operating these awkwardly controls. It is also envisioned that the present invention could also be applied to complex non-vehicular equipment, apparatuses or machinery where situational awareness is important to the proper and safe operation of the equipment and where it would be beneficial to intelligently or selectively display an input device when the user reaches for that input device.

Therefore, for other types of vehicles (e.g. automobiles) or for non-vehicular machinery or apparatuses, the display system would be fundamentally very similar. In other words, the display system would include an input device (e.g. a keypad) for receiving input (typed data input) from a user. The display system would also include a sensor (e.g. an IR sensor defining a sensing plane or a pair of digital cameras) for sensing a position of a user's finger relative to the input device and for generating a signal (such as image data signals 106, 108 as shown in FIG. 8) when the position of the user's finger relative to the input device is closer than a predetermined proximity threshold. The display system would also include a display for displaying a graphical representation of the input device in response to the signal.

The foregoing display system (which is understood to have utility beyond the realm of aviation) can also be generalized as a method for displaying an input device on a display to enable a user to ergonomically operate the input device while looking at a graphical representation of the input device on the display. This method includes steps of sensing a user's finger or hand, displaying the graphical representation of the input device on the display when the user's finger or hand is sensed to be in contact with, or proximate to, the input device.

For the purposes of this specification, it should be understood that references to detection of a user's (aviator's) finger or hand could also include sensing of any other object or body part that is used to operate an input device.

The sensing step would include steps of emitting infrared light from at least two orthogonal infrared lamps to define a sensing plane slightly above the input device, capturing digital images of the user's finger with digital cameras, triangulating a planar position of the user's finger over the input device, and correlating the position of the user's finger with one of a plurality of input elements of the input device.

Alternatively, the sensing step would include steps of generating image data of a user's finger using two digital cameras that capture images of the user's finger when proximate to the input device, processing the image data to resolve a three-dimensional position of a user's finger relative to the input device and for determining whether the three-dimensional position of the user's finger is within a predetermined proximity threshold of the input device, and correlating the position of the user's finger with one of a plurality of input elements of the input device.

Preferably, the displaying step includes steps of graphically depicting a real-time position of the user's finger relative to keys of a keypad with an icon, graphically depicting lightly touched keys of the keypad with a first color, and graphically depicting depressed keys with a second color. Preferably, the displaying step further includes graphically graying out inactive keys of the keypad. Preferably, the displaying step further includes graphically highlighting the key determined to be closest to the user's finger. Preferably, the displaying step includes graphically depicting either only letter labels or number labels inscribed on the keys of the keypad depending on a type of data being input.

Most preferably, the method is used in a cockpit of an aircraft for displaying information to an aviator. In this context, the displaying step includes graphically representing a cockpit input device (most preferably, at least one control and display unit (CDU) from a central console of an aircraft cockpit) when an aviator's finger penetrates the sensing plane to enable ergonomic operation of the input device (e.g. CDU) during flight.

This method therefore enables ergonomic operation of awkwardly located input devices which greatly alleviates aviator workload, strain and fatigue and helps to preserve situational awareness. Although this method is most useful for cockpit display systems, this method can also be utilized in automobiles, other vehicles or for complex non-vehicular equipment or machinery.

The embodiments of the present invention described above are intended to be exemplary only. Persons of ordinary skill in the art will readily appreciate that modifications and variations to the embodiments described herein can be made without departing from the spirit and scope of the present invention. The scope of the invention is therefore intended to be limited solely by the appended claims.

I/we claim:

1. A cockpit display system for displaying aircraft controls and instrumentation, the display system comprising:
an input device for receiving input from an aviator;
a sensor for sensing a proximity of an aviator's finger or hand to the input device; and
a display for displaying a graphical representation of the input device when the sensor senses that the aviator's finger or hand is proximate to the input device.

2. The cockpit display system as claimed in claim 1 wherein the display further comprises a real-time graphical depiction of a position of the aviator's finger or hand relative to the input device.

3. The cockpit display system as claimed in claim 2 wherein the display further graphically indicates an element of the input device when the aviator's finger is proximate to the element.

4. The cockpit display system as claimed in claim 3 wherein the input device is a control and display unit (CDU) having a keypad and wherein the display highlights a graphical representation of a key of the keypad when the aviator's finger is proximate to the key.

5. The cockpit display system as claimed in claim 4 wherein the display highlights the key with a distinct color when the aviator's finger lightly touches the key and highlights the key with another distinct color when the aviator's finger depresses the key.

6. The cockpit display system as claimed in claim 5 wherein the display indicates one or more inactivated keys with a grayed-out shading to indicate to the aviator that the one or more keys do not support any useful functionality at that particular time.

7. The cockpit display system as claimed in claim 1 wherein the sensor comprises a plurality of infrared (IR) sources and cameras defining a sensing plane substantially parallel to the input device.

8. The cockpit display system as claimed in claim 7 wherein the sensing plane is located approximately 1/16 to ⅛ of an inch (1.6 mm to 3.2 mm) above the input device.

9. The cockpit display system as claimed in claim 1 wherein the sensor comprises:
two orthogonal pairs of opposed, inwardly facing elongated infrared lamps defining a rectangular enclosure surrounding the input device, the elongated infrared lamps emitting infrared light to define a sensing plane slightly above the input device;
a digital camera located at each of the four corners of the rectangular enclosure for capturing digital images of the aviator's finger when placed within a field of vision of each the four cameras; and
a processor for triangulating a planar position of the finger over the input device and for correlating the position of the finger with one of a plurality of input elements of the input device.

10. The cockpit display system as claimed in claim 1 wherein the sensor comprises:
a pair of cameras for generating image data of an aviator's finger relative to the input device; and
a processor for processing the image data to resolve a three-dimensional position of an aviator's finger relative to the input device and for determining whether the three-dimensional position of the aviator's finger is within a predetermined proximity threshold of the input device.

11. The cockpit display system as claimed in claim 1 wherein the input device is a control and display unit (CDU) having a display screen and a keypad for inputting data and wherein the CDU is surrounded by a rectangular enclosure comprising:
an elongated infrared lamp disposed lengthwise along each of the four sides of the rectangular enclosure for creating an infrared sensing plane;
a digital camera at each corner of the rectangular enclosure for capturing digital images of an aviator's finger when placed in the sensing plane; and
a processor for triangulating the position of the aviator's finger from the digital images and correlating the position with a key of the keypad.

12. The cockpit display system as claimed in claim 11 wherein the display graphically represents the position of the aviator's finger in real-time using a visual cue to indicate to the aviator that his finger is proximate to the key.

13. The cockpit display system as claimed in claim 12 wherein the display graphically represents light contact with a key using a second visual cue to indicate to the aviator that he has lightly touched the key.

14. The cockpit display system as claimed in claim 13 wherein the display graphically represents a pressing of the key using a third visual cue to visually indicate to the aviator that he has depressed the key.

15. The cockpit display system as claimed in claim 1 wherein the input device comprises a manual throttle lever for controlling engine throttle and wherein the display graphically depicts the manual throttle lever when the sensor detects that the aviator's hand is closer to the manual throttle lever than a predetermined proximity threshold.

16. The cockpit display system as claimed in claim 1 wherein the input device comprises a panel of toggle switches and wherein the display graphically depicts the panel of toggle switches when the sensor detects that the aviator's hand is closer to the panel of toggle switches than a predetermined proximity threshold.

17. The cockpit display system as claimed in claim 1 wherein the display is a multi-function display (MFD) capable of displaying one of a plurality of input devices.

18. The cockpit display system as claimed in claim 1 wherein the display is an LCD multi-function display (MFD) having a split screen capability for simultaneously displaying two or more input devices.

19. The cockpit display system as claimed in claim 1 wherein the graphical representation of the input device is simplified by presenting on the display only those aspects of the input device that are relevant to the current function of the input device.

20. The cockpit display system as claimed in claim 19 wherein the input device comprises an alphanumeric keypad having a plurality of keys upon which are inscribed both numbers and letters and having a manual switch for switching between numeric and alphabetic input, wherein the display automatically presents only either the numbers or the letters depending on the data type being input, thereby simplifying visual presentation of the keypad to the aviator.

21. The cockpit display system as claimed in claim 1 wherein the display is selected from the group consisting of multi-function displays (MFD), heads-up displays (HUD) and helmet-mounted heads-up displays.

22. A display system comprising:
an input device for receiving input from a user;
a sensor for sensing a position of a user's finger relative to the input device and for generating a signal when the position of the user's finger relative to the input device is closer than a predetermined proximity threshold; and
a display for displaying a graphical representation of the input device in response to the signal.

23. The display system as claimed in claim 22 wherein the display graphically depicts in real-time the position of the user's finger relative to the input device.

24. The display system as claimed in claim 23 wherein the display graphically depicts light contact between the user's finger and an input element of the input device to indicate to the user that the user has lightly touched the input element but has not yet fully actuated the input element.

25. The display system as claimed in claim 24 wherein the display graphically depicts full actuation of the input element in a manner that is visually distinct from a graphical depiction of light contact.

26. The display system as claimed in claim 25 wherein the display uses a moving icon to represent the changing position of the user's finger, a first color to represent light contact with the input element and a second color to represent full actuation of the input element.

27. The display system as claimed in claim 22 wherein the input device comprises a keypad having a plurality of keys, wherein the display graphically depicts the position of the user's finger with a first visual cue, light contact with any of the keys with a second visual cue and full actuation of any of the keys with a third visual cue.

28. The display system as claimed in claim 27 wherein the display graphically depicts inactive keys with a fourth visual cue.

29. The display system as claimed in claim 27 wherein the display highlights the key on the keypad that is sensed to be closest to the user's finger.

30. The display system as claimed in claim 22 wherein the sensor comprises:
a plurality of infrared sources emitting infrared light in a sensing plane;
a plurality of digital cameras for detecting the user's finger when situated in the sensing plane, the sensing plane being disposed above and parallel to the input device to thus define the predetermined proximity threshold for activating the graphical representation of the input device on the display; and
a processor for triangulating the position of the user's finger when placed into the sensing plane.

31. The display system as claimed in claim 30 wherein the sensing plane is located approximately 1/16 to ⅛ of an inch (1.6 mm to 3.2 mm) above the input device.

32. The display system as claimed in claim 22 wherein the sensor comprises:
a pair of cameras for detecting the user's finger; and
a processor for computing the position of the user's finger in three-dimensional space relative to the input device and for determining whether a distance between the position of the user's finger and the input device is less than the predetermined proximity threshold.

33. The display system as claimed 22 in claim wherein the display is a multi-function display (MFD).

34. A method for displaying an input device on a display to enable a user to ergonomically operate the input device while looking at a graphical representation of the input device on the display, the method comprising steps of:
sensing a user's finger or hand;
displaying the graphical representation of the input device on the display when the user's finger or hand is sensed to be in contact with, or proximate to, the input device.

35. The method as claimed in claim 34 wherein the sensing step comprises determining when the user's finger positioned proximate to the input device.

36. The method as claimed in claim 34 wherein the sensing step comprises determining when the user's finger is in contact with the input device.

37. The method as claimed in claim 35 wherein the sensing step comprises:
emitting infrared light from at least two orthogonal infrared lamps to define a sensing plane slightly above the input device;
capturing digital images of the user's finger with digital cameras;
triangulating a planar position of the user's finger over the input device; and
correlating the position of the user's finger with one of a plurality of input elements of the input device.

38. The method as claimed in claim 35 wherein the sensing step comprises:
generating image data of a user's finger using two digital cameras that capture images of the user's finger when proximate to the input device;
processing the image data to resolve a three-dimensional position of a user's finger relative to the input device and for determining whether the three-dimensional position of the user's finger is within a predetermined proximity threshold of the input device; and
correlating the position of the user's finger with one of a plurality of input elements of the input device.

39. The method as claimed in claim 34 wherein the input device is a control and display unit (CDU) having a keypad and screen for receiving and displaying various types of input from an aviator, the display also displaying a graphical representation of the keypad and screen of CDU.

40. The method as claimed in claim 34 wherein the displaying step comprises a step of displaying the graphical representation of one or both a pair of side-by-side control and display units on at least one multi-function display having a split-screen capability.

41. The method as claimed in claim 34 wherein the displaying step comprises a step of graphically depicting a real-time position of the user's finger relative to input elements of the input device.

42. The method as claimed in claim 41 wherein the displaying step further comprises a step of graphically depicting light contact between the user's finger and one or more of the input elements of the input device.

43. The method as claimed in claim 42 wherein the displaying step further comprises a step of graphically depicting an act of depressing one or more of the input elements of the input device.

44. The method as claimed in claim 43 wherein the displaying step further comprises a step of graphically depicting inactive keys.

45. The method as claimed in claim 34 wherein the displaying step further comprises graphically depicting only active input elements and relevant input element labels, thereby visually presenting to the user a simplified version of the input device.

46. The method as claimed in claim 34 wherein the displaying step comprises steps of:
graphically depicting a real-time position of the user's finger relative to keys of a keypad with an icon;
graphically depicting lightly touched keys of the keypad with a first color; and
graphically depicting depressed keys with a second color.

47. The method as claimed in claim 46 wherein the displaying step further comprises graphically graying out inactive keys of the keypad.

48. The method as claimed in claim 37 wherein the displaying step comprises steps of:
graphically depicting a real-time position of the user's finger relative to keys of a keypad with an icon;
graphically depicting lightly touched keys of the keypad with a first color; and
graphically depicting depressed keys with a second color.

49. The method as claimed in claim 48 wherein the displaying step further comprises graphically graying out inactive keys of the keypad.

50. The method as claimed in claim 48 wherein the displaying step further comprises graphically highlighting the key determined to be closest to the user's finger.

51. The method as claimed in claim 48 wherein the displaying step comprises graphically depicting either only letter labels or number labels inscribed on the keys of the keypad depending on a type of data being input.

52. The method as claimed in claim 48 wherein the displaying step comprises graphically representing at least one control and display unit (CDU) from an aircraft cockpit when an aviator's finger penetrates the sensing plane to enable ergonomic operation of the CDU during flight.
